(19) United States
(12) Patent Application Publication
(10) Pub. No.: US 2025/0235775 A1
(43) Pub. Date: Jul. 24, 2025

(54) Modular Ski Transport Device with Adhesive Base and Rolling Element

(71) Applicants: Angela Eyaralar Alvarez, Gijon Asturias (ES); Cristina Eyaralar Alvarez, Gijon Asturias (ES); Cristina Margarita Alvarez Aguirrezabala, Gijon Asturias (ES)

(72) Inventors: Angela Eyaralar Alvarez, Gijon Asturias (ES); Cristina Eyaralar Alvarez, Gijon Asturias (ES); Cristina Margarita Alvarez Aguirrezabala, Gijon Asturias (ES)

(21) Appl. No.: 18/986,646

(22) Filed: Dec. 18, 2024

Related U.S. Application Data
(60) Provisional application No. 63/629,943, filed on Dec. 18, 2023.

(51) Int. Cl. A63C 11/02; B62B 5/00

(52) U.S. Cl. CPC A63C 11/026; B62B 5/0083; B62B 2301/25; B62B 2301/33

(57) ABSTRACT

The invention is a modular ski transport device with an adhesive attachment system for easy, non-invasive ski transport. It features a rolling element for smooth movement on snow, ice, and paved surfaces. The adhesive base provides secure attachment under extreme conditions and is easily removable without damaging the ski. Lightweight and portable, the tool-free structure is ideal for crowded areas, offering a compact and efficient solution for varied terrains.

### FIELD OF THE INVENTION

The present invention relates to compact, modular, and detachable systems for transporting skis and similar equipment. It features an adhesive-based attachment system, a rolling element for smooth multidirectional movement, and a lightweight structure adaptable to various terrains such as snow, ice, and paved roads.

### BACKGROUND OF THE INVENTION

Transporting skis presents challenges due to their weight, length, and awkward handling. Existing solutions often lack efficiency, portability, or the ability to avoid damage during transport. Common issues include user fatigue, instability, and risk of damage to skis. Additionally, many devices require permanent modifications or lack versatility across terrains. The present invention resolves these problems with a modular, adhesive-based attachment system and a rolling element that ensures smooth, multidirectional movement on various surfaces.

Transporting skis is challenging due to their weight, length, and awkward shape. Men's skis weigh 8.8 to 11 pounds, and women's skis weigh 6.6 to 8.8 pounds, making them difficult to handle over long distances, uneven surfaces, or crowded areas. Existing solutions fail to address key issues such as comfort, usability, adaptability to varying terrains, and equipment protection, while often neglecting environmental impact and user safety.

Numerous devices have been proposed to assist with ski transport, but must have notable limitations:

Wheeled Carts: Wheeled carts are cumbersome to store in ski resorts, vehicles, or small spaces. They are often unsuitable for short distances due to their size, weight, and setup time, and perform poorly on rugged terrains like snow, ice, or slopes.

Velcro Straps and Mechanical Clamps: Velcro straps fail under wet or freezing conditions, while mechanical clamps require time-consuming installation, often involving drilling that compromises ski integrity. Both are impractical for uneven, snowy, or rugged terrains.

Rigid Carriers: These devices require complex assembly or tools and are bulky, making them impractical in environments like ski resorts where space and mobility are limited.

Despite various existing solutions, a gap remains for a compact, lightweight, modular, and non-invasive transport device that: does not require permanent ski modifications, provides smooth multidirectional movement on diverse terrains like snow, ice, and paved roads, can be installed and removed without tools, and performs reliably under extreme conditions, including freezing temperatures, moisture, and corrosive agents.

Adhesive-Based Attachment System: The adhesive provides a strong bond that withstands vibrations, dynamic forces, and temperatures from −40° C. to +150° C. It resists moisture, UV radiation, and corrosive agents like de-icing salts, ensuring reliable performance in snow and wet conditions. The adhesive allows for easy removal using heat or solvents, leaving no residue. It remains firmly attached during skiing and does not interfere with ski performance. The lightweight base adds minimal weight.

Rolling Element with Bearings: The rolling element (sphere, wheel, or cylinder) allows smooth, multidirectional movement on paved roads, snow, and slopes. Textured surfaces improve grip on snow, while seal-skin coatings enable uphill transport and braking downhill. Bearings reduce friction and enhance performance on uneven or high-friction terrains like rugged or icy surfaces.

Modular and Lightweight Design: The support structure, made of lightweight yet durable materials like aluminum or engineering plastics, ensures strength and portability. The modular design allows tool-free assembly and disassembly, facilitating compact storage and easy transport.

The present invention offers clear advantages over existing solutions: Convenience for Short Distances: Its modular design allows users to detach the rolling element and store it in a pocket, making it practical for short trips or crowded areas like ski lift queues. Non-Invasive Design: Unlike traditional methods requiring permanent ski modifications, the adhesive system preserves the equipment's value and usability. Durability: The adhesive remains intact under extreme conditions, including temperature changes and moisture, and performs reliably in real-world skiing scenarios

The invention has significant commercial potential, especially for ski rentals and resorts where space is limited. Rental shops can offer it to customers for easier transport from rental desks to slopes. Resorts benefit from its lightweight and compact design, which suits crowded environments. It is particularly helpful for users walking long distances from parking lots to ski lifts or hotels to slopes, minimizing inconvenience and reducing the need for bulky equipment.

Lockers in ski resorts are often expensive or unavailable during peak seasons. This invention eliminates the need for lockers by offering a compact and cost-effective transport solution. It also addresses parking challenges near ski resorts, where limited space and environmental regulations often complicate access. The device provides a practical option for users parking at distant lots, making ski transport more manageable.

In some ski resorts, cars may be restricted or difficult to access. This transport device enables easy foot travel with minimal gear, providing a sustainable and efficient alternative to carrying heavy equipment.

### SUMMARY OF THE INVENTION

The invention is a compact, modular, and detachable ski transport device that integrates a customizable rolling element, a lightweight support structure, and an adhesive-based attachment system. The adhesive ensures a secure bond under extreme conditions, including freezing temperatures and moisture, while allowing easy removal without damaging the ski surface. The device enables smooth, multidirectional movement across snow, ice, and paved roads, preserving the ski's integrity.

Existing solutions like bulky carts, Velcro straps, or mechanical clamps arc inconvenient and often require permanent ski modifications. This invention addresses these issues with a non-invasive, easily removable adhesive system that requires no tools, making it ideal for short distances and crowded environments like ski resorts.

The invention is commercially viable for ski rentals and resorts with limited space. It is also useful in ski-in/ski-out locations, enabling users to transport skis from parking lots or accommodations to slopes without heavy or bulky equipment.

Key features include a secure adhesive attachment that resists moisture, UV radiation, and road salts, a customizable rolling element enabling smooth, multidirectional movement across diverse terrains, and a lightweight, modular design that allows for easy storage, portability, and tool-free installation.

This invention provides a user-friendly, cost-effective ski transport system that overcomes the limitations of existing solutions. It is adaptable to varying terrains and conditions, making it suitable for personal and commercial applications.

### DETAILED DESCRIPTION OF THE INVENTION

The present invention is a modular, detachable ski transport device that facilitates rolling movement of skis. The device uses a high-performance adhesive (323) to securely attach the attachment base (32) to the ski surface, ensuring a strong bond without requiring permanent modifications.

The device also includes secondary connection systems, such as magnetic retention systems and clips, for temporary stabilization during actions like flipping skis for transport. These systems ensure stability but do not replace the adhesive as the primary attachment mechanism.

### SUMMARY OF THE INVENTION

The invention improves ski transportation by reducing user fatigue, instability, and equipment damage. It provides a lightweight, portable, and adaptable system for smooth, multidirectional movement across various terrains and ski geometries.

### BRIEF DESCRIPTION OF THE DRAWINGS

FIG. 1 illustrates a ski with the transport device applied, showing the rolling element (4) positioned near the tip of the ski. Components include:
1: Ski
6: First Surface of the Ski
4: Rolling Element
32: Adhesive Base
6′: Sliding Surface of the Ski

FIG. 2 depicts the same device with the rolling element (4) positioned near the back of the ski. Components include:
1: Ski
6: First Surface of the Ski
4: Rolling Element
32: Adhesive Base
6′: Sliding Surface of the Ski

FIG. 3 shows an exploded view of the device, highlighting:
32: Adhesive Base
311: U-Shaped Support Structure
4: Rolling Element
31: Rotating Axis
9: Nut System

FIG. 4 depicts the U-shaped support arm (311) with the rolling element (4) attached, illustrating the modular assembly process. Components include:
311: U-Shaped Support Arm
4: Rolling Element
312: Second End Housing Connection
32: Adhesive Base

FIG. 5 is a close-up of the adhesive base (32), showing the housing slot (321) and adhesive layer (323).

FIG. 6 presents a cross-sectional view of the support arm (311) with the rolling element (4) mounted on bearings. Components include:
311: U-Shaped Support Arm
4: Rolling Element
31: Rotating Axis

FIG. 7 illustrates the magnetic retention system (3211) securing the U-shaped support arm (311) within the housing slot (321) of the adhesive base (32).

FIG. 8 shows the rotating axis (31) that allows the rolling element (4) to rotate smoothly across various terrains.

FIG. 9 depicts the nut system (9) that secures the rotating axis (31) to the U-shaped support arm (311).

FIG. 10 demonstrates a user actively using the ski transport device, showcasing its ergonomic design and ease of use for transporting skis.

FIGS. 11, 12, and 13 illustrate the adhesive base (32) with angle configurations (0°, 3°, and 5°) designed to fit various ski geometries.

FIG. 14 shows a perspective view of the adhesive base (32) attached to the upper surface of the ski (6). The relationship between the adhesive base and the ski structure (2) is illustrated, highlighting its compact design and seamless integration without requiring permanent modifications to the equipment.

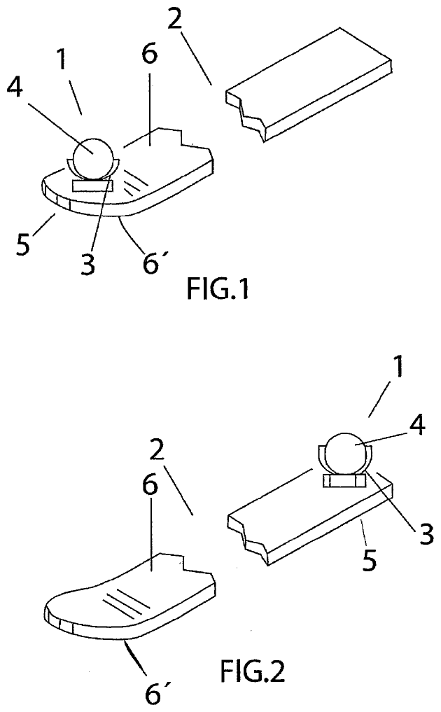

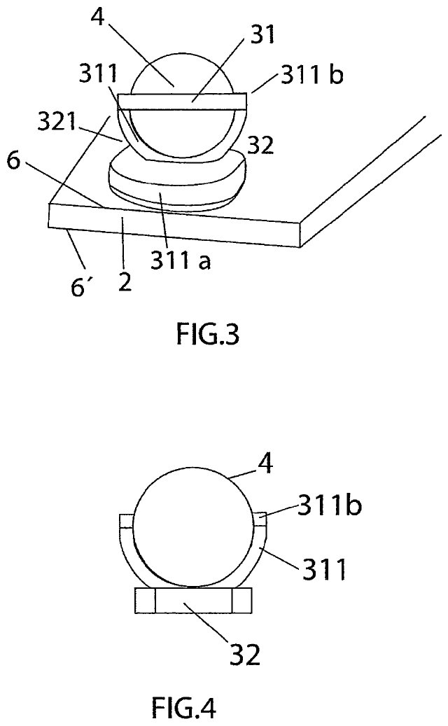

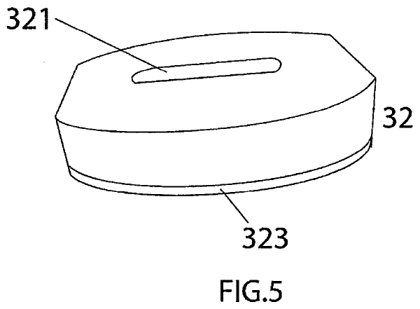

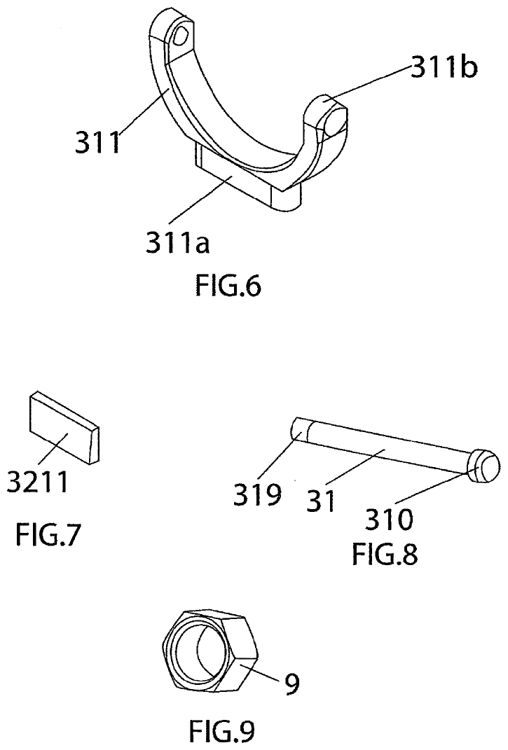

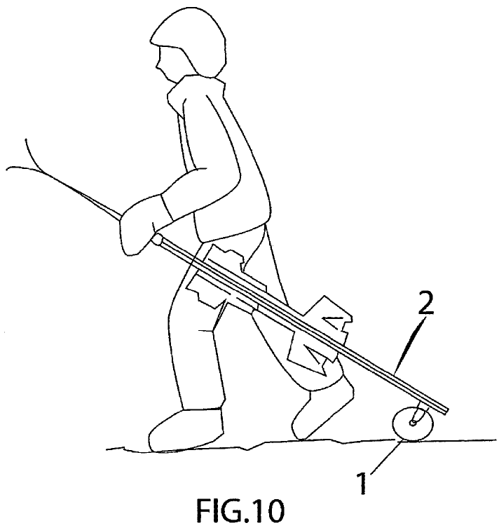

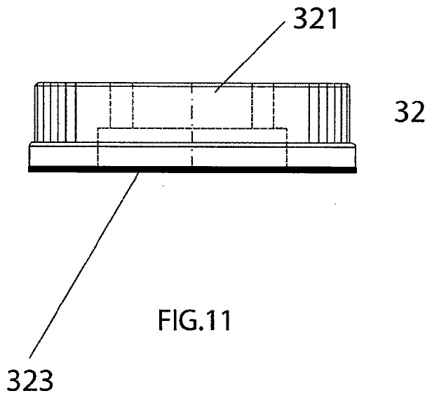

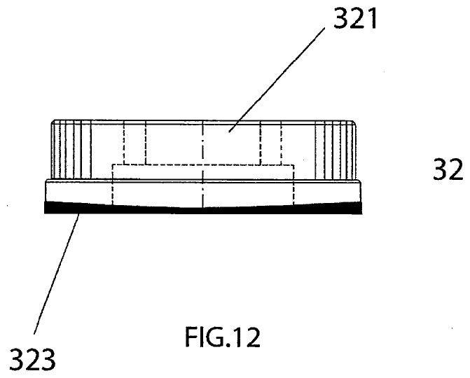

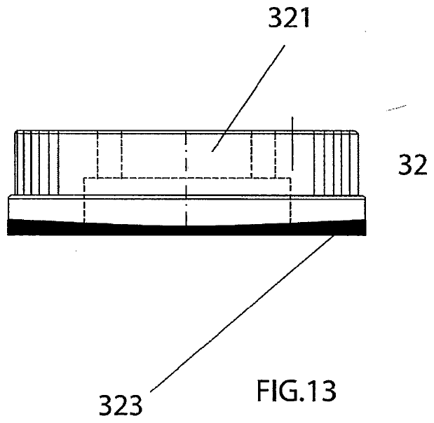

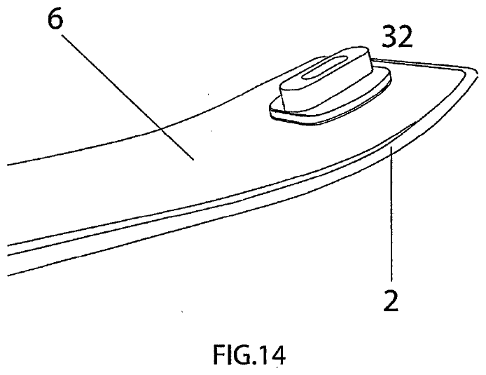

### REFERENCE NUMERALS

1: Device (overall)
2: Ski
6: First Surface of the Ski.
6′: Sliding Surface of the Ski
32: Adhesive Base
323: Adhesive Layer
321: Housing
311: U-Shaped Support Arm
311a: First End of the Support Arm
311b: Second End of the Support Arm
31: Rotating Axis
9: Nut System
4: Rolling Element
3211: Magnetic Retention System

### DETAILED DESCRIPTION OF THE INVENTION

Adhesive Base (32): The adhesive base (32) secures the transport device to the ski. It is made from durable, impact-resistant material and includes adhesive (323) on its underside for a strong bond with the ski.

Material and Design: The adhesive base is constructed from high-strength materials resistant to impact, vibrations, freezing temperatures, UV radiation, moisture, and corrosive agents like de-icing salts. The adhesive (323) adheres securely to the ski's upper surface (6) without causing damage.

The adhesive base (32) is available in various geometrical configurations to accommodate different ski designs. A 0° base is optimized for flat-tailed skis, while a 3+ base is designed for flared-tail skis, and a 5° base is suitable for twin-tip skis. Additionally, specialized bases are available for cross-country and touring skis, ensuring compatibility across a wide range of ski geometries.

The connection options for the adhesive base (32) include a magnetic retention system designed to temporarily secure the support structure during use. Additional stability can be provided through clips, pressure-fit systems, or small screws. For high-impact conditions, reinforced mechanical systems are available to ensure a secure and durable attachment.

Alternative Connection System: The housing (321), a cavity in the adhesive base (32), secures the support arm (311) with options like magnetic retention systems (3211), clips, or other locking mechanisms. The lower portion of the housing may include magnetic or mechanical retention to keep the support arm in place during use.

In addition to the primary adhesive-based attachment, the device includes alternative connection systems such as magnetic retention mechanisms (3211) or clips. These auxiliary systems temporarily secure the support structure (311) within the housing (321) during actions like flipping the skis for transport. They provide added stability, preventing the support arm (311) from detaching under dynamic conditions, but are secondary and not the primary attachment mechanism.

The adhesive base (32) includes a protective cover for the cavity (321) when the device is not in use or while skiing. This cover shields the internal mechanism from environmental factors such as snow, dirt, or water, maintaining the device's functionality and condition.

The protective cover is made from durable materials like silicone, thermoplastic elastomers (TPE), rubber, or EVA foam. It resists extreme temperatures, moisture, and wear, protecting the device during non-use or skiing activities.

The cover fits securely over the cavity (321) and can be easily removed when the device is in use. It ensures internal components are safeguarded from snow, water, and dirt, maintaining functionality in various conditions.

The silicone cover enhances durability by sealing the cavity (321) from external elements. It is easy to apply or remove without tools, ensuring the device remains ready for use and well-protected.

The silicone cover can be designed as a removable component for user convenience or integrated into the adhesive base (32) as a permanent feature, ensuring continuous protection when the device is not in use.

The support structure (311) connects the rolling element (4) to the adhesive base (32), providing stability. It is made from lightweight, high-strength materials such as aluminum, stainless steel, carbon-fiber-reinforced polymers, or engineered plastics like nylon.

Design variations include U-shaped support structures (311) for spherical rolling elements and adapted geometries for cylindrical or semi-spherical rolling elements to ensure proper alignment and attachment.

Enhanced features include shock-absorbing designs for uneven terrains and adjustable configurations for optimal ground clearance based on terrain type and ski geometry.

The rotating axis (31) enables the rolling element (4) to rotate smoothly for multidirectional movement. It can be secured to the support structure (311) using a screw (9) or an integrated threaded hole, eliminating the need for additional components.

The rolling element (4) facilitates smooth movement during ski transport. Made from durable materials like polyurethane, rubber, or thermoplastics, it includes scaled stainless steel bearings to reduce friction and protect against environmental factors like moisture and dirt. The rolling element can be configured as a sphere, cylinder, or semi-spherical shape to suit different terrains.

The rolling element (4) facilitates smooth, multidirectional movement for ski transport. Constructed from durable materials like polyurethane, rubber, or thermoplastics, it includes sealed stainless steel bearings to minimize friction and protect against moisture, dirt, and vibrations. Configurations include spherical, cylindrical, or semi-spherical shapes to suit different terrains.

Materials such as aluminum, stainless steel, carbon-fiber-reinforced polymers, nylon, and other plastics mentioned throughout are examples and not limiting. Any material meeting functional, mechanical, and durability requirements can be used.

Adhesive Base Installation: Clean the ski surface thoroughly. Attach the adhesive base (32) securely, aligning with the ski geometry. Insert the support structure (311) into the connection system (e.g., magnetic retention, clips, or screws) and ensure proper alignment for stability and smooth movement. To remove, apply heat to weaken the adhesive bond for easy, residue-free detachment.

Once assembled, the device ensures efficient ski transportation. The user can direct movement by tilting the ski, while the rolling element (4) rotates freely, allowing smooth movement across snow, ice, or paved surfaces. The secure attachment system and geometric design provide stability during use.

The invention offers technical advantages over existing solutions, including: no need for drilling or permanent modifications, quick installation and removal without tools, adaptability to various ski geometries and terrains, resistance to extreme temperatures, vibrations, and moisture, and surfaces optimized for different terrains.

Assembly options include cylindrical or semi-spherical configurations tailored for specific terrains, heat-activated or moisture-resistant materials for complex geometries, and snap-fit locks, pressure-fit systems, or reinforced screws. Specially designed bases ensure compatibility with niche ski designs.

This invention provides a modular, efficient solution for ski transport. Integrating an adhesive base (32), a rolling element (4), and a detachable support structure (311), it simplifies transport, enhances convenience, and ensures stability across terrains. Its versatility and durability make it a significant improvement over traditional methods.

1. A ski transport device, comprising:
A modular, detachable support structure;
An adhesive base comprising an adhesive that provides a secure attachment, capable of withstanding extreme conditions and facilitating easy removal without requiring permanent modifications to the ski surface;
A rolling element detachably connected to the support structure, wherein the rolling element is configured to provide multidirectional movement across varied terrains, and wherein the rolling element is configured for easy removal and storage in a user's pocket or bag when not in use.

2. The ski transport device of claim 1, wherein the rolling element comprises a spherical, cylindrical, or semi-spherical shape and includes optional bearings to reduce mechanical resistance and improve stability across rugged terrains.

3. The ski transport device of claim 1, wherein the adhesive base allows attachment and removal without requiring permanent modifications to the ski surface.

4. The ski transport device of claim 1, wherein the adhesive base includes a shock-resistant material designed to absorb and resist impacts, thus enhancing the durability and performance of the device during high-impact use. This shock-resistant material helps protect the internal components of the device from damage caused by rough handling, collisions, or impacts commonly encountered during skiing activities.

5. The ski transport device of claim 1, wherein the adhesive base remains on the ski surface during use and does not interfere with the performance of the ski.

6. The ski transport device of claim 1, wherein the rolling element is coated with a textured surface to optimize traction on snow, or a smooth surface for paved or hard surfaces.

7. The ski transport device of claim 1, wherein the adhesive base includes configurations with adjustable angles to align with various ski geometries, such as flat-tailed skis, flared-tail skis, and twin-tip skis.

8. The ski transport device of claim 1, wherein the modular design allows for easy and tool-free installation and removal of the support structure, and is lightweight enough to ensure compact storage and easy portability.

9. The ski transport device of claim 1, wherein the rolling element is removably attached and stored separately to allow for compact transportation and reduced bulk.

10. The ski transport device of claim 1, wherein the adhesive base is capable of adhering securely to a variety of ski surfaces, including complex geometries, ensuring compatibility across different ski designs and ensuring a firm bond without modifying the ski.

11. A method for transporting a ski, comprising the steps of:
Attaching an adhesive base to the surface of the ski using an adhesive that provides a secure attachment, as described in claim 1;
Mounting a modular support structure onto the adhesive base;
Connecting a rolling element to the support structure;
Moving the ski across various terrains by utilizing the rolling element, enabling smooth and efficient transport.

12. The method of claim 11, wherein the adhesive base is designed to remain on the ski surface during use without interfering with the performance or handling of the ski.

13. The method of claim 11, wherein the rolling element is removable and stored in a pocket or bag when not in use to ensure convenience and portability.

14. The method of claim 11, further comprising the step of removing the adhesive base by applying heat or using other methods that allow for easy removal without damaging the ski surface.

15. The ski transport device of claim 1, wherein the rolling element further comprises a surface coating designed to enhance grip on both uphill and downhill movements.

16. The ski transport device of claim 1, wherein the modular design enables adaptation for use with a variety of ski geometries, including cross-country skis and other elongated equipment.
